(19) United States
(12) Patent Application Publication
(10) Pub. No.: US 2006/0049132 A1
(43) Pub. Date: Mar. 9, 2006

(54) Etchant composition and the use thereof

(75) Inventors: Chang-Rong Wu, Taipei (TW); Yinan Chen, Taipei (TW)

Correspondence Address: BACON & THOMAS, PLLC, 625 SLATERS LANE, FOURTH FLOOR, ALEXANDRIA, VA, 22314, US

(73) Assignee: NANYA Technology Corporation, Taoyuan (TW)

(21) Appl. No.: 10/934,382

(22) Filed: Sep. 7, 2004

(51) Int. Cl. C09K 13/00; H01B 13/00; B44C 1/22

(52) U.S. Cl. 216/17; 252/79.1; 252/79.3; 216/58; 216/79

(57) ABSTRACT

The present invention relates to an etchant composition and the use thereof.

### BACKGROUND OF THE INVENTION

The present invention relates to an etchant composition and the use thereof.

The manufacture of semiconductors includes two basic etching processes: dry etching and wet etching. Dry etching is the major etching process for removing surface materials. Although wet etching has been enormously replaced by dry etching, it plays an important role in oxides cleaning, residues removal and surface stripping and big area etching, etc. Additionally, the wetting cleaning of wafers is also recognized as one kind of wet etching processes.

For example, etching residues, including the polymers formed from the etching gases (e.g., C₂F₄, etc.) and the by-products of etching, are always left in the bottom of the etched profile after dry etching of oxides and polysilicon. Hence, after the dry etching process, wet etching would sometimes be performed to remove such kind of residues. To effectively remove said residues and achieve a better etching profile, it is desirable to use an etchant composition with low silicon/silicon oxides selectivity to carry out the wet etching process. However, the known etchant compositions that are commonly used in the conventional wet etching processes cannot achieve the above object due to lack of low silicon/silicon oxides selectivity. For example, the mixed solutions of HNO₃/HF/CH₃COOH tend to etch silicon, and HF or HF/NH₄F etches oxides more easily.

### BRIEF SUMMARY OF INVENTION

To meet the need of the semiconductor applications as described above, one of the objects of the present invention is to provide an etchant composition with low silicon/silicon oxides selectivity.

Another object of the present invention is to provide a process for cleaning residues in the hole after etching.

Another object of the present invention is to provide a process for forming a bottle-shaped trench.

A further object of the present invention is to provide a process for cleaning the hole after etching of polysilicon.

### BRIEF DESCRIPTION OF THE DRAWINGS

FIG. 1 is a diagram showing the thickness loss of polysilicon layer, thermal oxide layer, BPSG layer and NSG layer respectively etched by the etchant composition of the present invention versus time.

### DETAILED DESCRIPTION OF INVENTION

The present invention provides an etchant composition, prepared from 100 wt. % of NH₄F aqueous solution, 49 wt. % of HF and CₙH₂ₙ₊₁OH, in which 100 wt. % of NH₄F aqueous solution:49 wt. % of HF:CₙH₂ₙ₊₁OH=300-500:1:10-20 in volume ratios; and n is an integer of less than 6. The concentrations of NH₄F and HF are expressed as weight parts of NH₄F and HF contained in 100 weight parts of water. Preferably, in the etchant composition of the present invention, the volume ratios of 100 wt. % of NH₄F aqueous solution:49 wt. % of HF:CₙH₂ₙ₊₁OH equals 400:1:15, and n is 3. The etchant composition of the present invention can etch silicon (particularly polysilicon) and silicon oxides (particularly SiO₂) at the same etch rate. Specifically, the etchant composition of the present invention etches SiO₂ and polysilicon both at the etch rate of approximately 20±1 Å/min. In other words, the etchant composition of the present invention has an etch selectivity of 1 for SiO₂ to polysilicon. Further, the etchant composition of the present invention does not etch nitrides and Al₂O₃. The etchant composition of the present invention etches borophosphosilicate glass (BPSG) and non-doped silicate glass (NSG) respectively at etch rates of about 140±35 Å/min and about 120±5 Å/min.

Another object of the present invention is to provide a process for cleaning residues in etched holes, comprising using the etchant composition of the present invention to clean the etched holes after etching part of the oxide layer on the silicon substrate. Because the etchant composition of the present invention has an etch selectivity of 1 for silicon oxides to silicon, it can remove the etch residues and in the meantime provides a good etch profile. Thus, the problem of negative angles that is caused by overetch of the silicone substrate with the conventional etchant compositions having high etch selectivity of silicon/silicon oxides would not occur. Further, NSG and/or BPSG layers may be optionally deposited on the oxide layer. After etching part of NSG and/or BPSG layers, the etchant composition of the present invention may be used to clean the etched holes in order to facilitate the subsequent procedures, such as sputtering of metal layers or deposition of metal layers by chemical vapor deposition (CVD).

Another object of the present invention is to provide a process for forming a bottle-shaped trench, characterized in that the etchant composition of the present invention is used to etch the lower part of the trench that penetrates into the silicon substrate and is not covered by a protective layer (e.g., silicon nitride layer or Al₂O₃ layer), while the protective layer on the side wall of the upper part of trench is not etched.

A further object of the present invention is to provide a process for cleaning etched holes after etching polysilicon, comprising using the etchant composition of the present invention. Specifically, in the manufacture of a semiconductor, sometimes a polysilicon layer would be laid between the oxide layer and the photoresist layer on the films (e.g., silicon or polysilicon or tungsten, etc.) to reduce the thickness of the photoresist layer, thereby improving the resolution of photolithography. After removing the photoresist layer and dry etching part of the polysilicon layer, the etchant composition of the present invention may be used to clean the etched holes while said holes exhibit a good etch profile.

### EMBODIMENTS OF INVENTION

The etchant composition of the present invention was prepared from 100 wt. % NH₄F aqueous solution, 49 wt. % HF and n-propanol by conventional methods, in which 100 wt. % NH₄F aqueous solution:49 wt. % HF:n-propanol=400:1:15 in volume ratios. The following experiments were performed to test the etch rates of the etchant composition of the present invention against different materials.

Method

A polysilicon layer, oxide layer, nitride layer, Al₂O₃ layer, borophosphosilicate glass layer (BPSG) layer and non-doped silicate glass layer were respectively deposited on individual silicon wafer. The silicon wafers having different materials deposit thereon were impregnated with the etchant composition of the present invention for a period of time specified in Table 1. The loss of thickness of materials caused by etching was calculated by respectively measuring the thickness of the materials before and after impregnation with the etchant composition of the present invention using a coating thickness meter.

Result

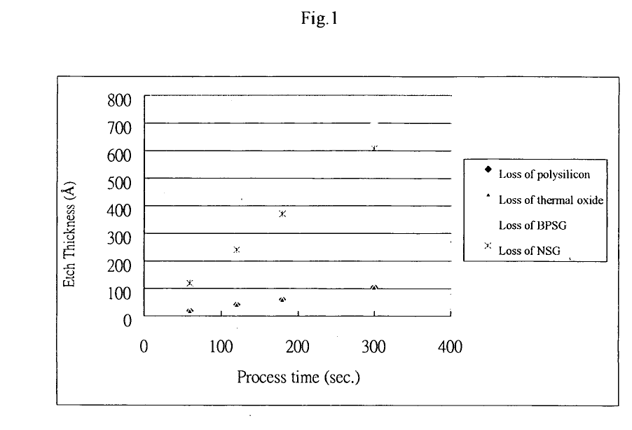

The results obtained from etching different test materials with the etchant composition of the present invention were shown in Table 1 and FIG. 1.

TABLE 1

| | | | Loss of | | | |
|---|---|---|---|---|---|---|
| | | | Nitride | Loss of | | |
| | | Loss of | (by | Al₂O₃ (by | | |
| | Loss of | thermal | deposition | deposition | Loss | Loss |
| Etch | Poly- | oxide | under low | of atomic | of | of |
| Process | silicon | layer | pressure) | layers) | BPSG | NSG |
| (sec) | (Å) | (Å) | (Å) | (Å) | (Å) | (Å) |
| 60 | 20 | 20 | 0 | 0 | 140 | 120 |
| 120 | 41 | 40 | 0 | 0 | 282 | 240 |
| 180 | 60 | 61 | 0 | 0 | 523 | 370 |
| 300 | 102 | 103 | 1 | 0 | 706 | 606 |
| Etch | about | about | 0 | 0 | about | about |
| Rate | 20 | 20 | | | 140 | 120 |
| (Å/min) | | | | | | |

### USE EXAMPLES

The following examples are merely used to illustrate the applications of the present invention and the efficacy achieved, but do not intend to limit the present invention. It can be understood by a skilled artisan that any modifications or changes without departing from the spirit and scope of the present invention can be made. The protection scope of the present invention is as defined in the annexed claims.

### Example 1

After part of the oxide layer on a silicon substrate was etched, the silicon substrate was impregnated with the etchant composition of the present invention to clean the etched hole. The result shows that the etch residues can be effectively removed and the etched hole exhibits a good etch profile, while no negative angle that is usually caused by over-etch with conventional etchant compositions with high silicon/silicon oxides etch selectivity was found.

### Example 2

A silicon substrate was respectively deposited with an oxide layer and a nitride layer. After forming a deep trench by etching, the upper part of the deep trench was covered with silicon nitride or Al₂O₃ as a protective later. Then, wet etching was performed by using the etchant composition of the present incvention. The lower part of the deep trench that penetrated into the silicon substrate and was not covered with a protective layer was etched, but the protective layer on the upper sidewall of the deep trench was not etched. As a result, a bottle-shaped trench is formed.

### Example 3

To improve the resolution of the microlithography, a polysilicon layer was arranged between the oxide layer and photoresist layer on the film to reduce the thickness of the photoresist layer. After removing the photoresist layer and dry etching part of the polysilicon layer, the etched hole was cleaned with the etchant composition of the present invention. Said hole exhibits a good etch profile.

1. An etchant composition, prepared from 100 wt. % of NH₄F aqueous solution, 49 wt. % of HF and CₙH₂ₙ₊₁OH, in which 100 wt. % of NH₄F aqueous solution:49 wt. % of HF:CₙH₂ₙ₊₁OH=300-500:1:10-20 in volume ratios; and n is an integer of less than 6.

2. An etchant composition according to claim 1, wherein 100 wt. % of NH₄F aqueous solution:49 wt. % of HF:CₙH₂ₙ₊₁OH=400:1:15 in volume ratios; and n equals 3.

3. A process for removing the residues in the etched hole, comprising using an etchant composition according to claim 1 to clean the etched hole after part of oxide on the silicon substrate is etched.

4. A process according to claim 3, wherein part of oxide layer is etched by dry etching.

5. A process for forming a bottle-shaped deep trench, characterized in that an etchant composition according to claim 1 is used to etch the lower part of the trench that penetrates into the silicon substrate and is not covered with a protective layer, while the protective layer on the sidewall of the upper part of the trench is not etched.

6. A process according to claim 5, wherein said protective layer is silicon nitride layer or Al₂O₃ layer.

7. A process for cleaning the etched hole after etching polysilicon, comprising using an etchant composition according to claim 1.
